(19) United States
(12) Patent Application Publication
(10) Pub. No.: US 2017/0248436 A1
(43) Pub. Date: Aug. 31, 2017

(54) CENTRALIZED OBJECT TRACKING FOR MOBILE PLATFORMS

(71) Applicant: GM GLOBAL TECHNOLOGY OPERATIONS LLC, Detroit, MI (US)

(72) Inventors: CLAUDIA V. GOLDMAN-SHENHAR, MEVASSERET ZION (IL); KOBI J. SCHEIM, PARDESS HANNA (IL)

(73) Assignee: GM GLOBAL TECHNOLOGY OPERATIONS LLC, Detroit, MI (US)

(21) Appl. No.: 15/445,386

(22) Filed: Feb. 28, 2017

Related U.S. Application Data
(60) Provisional application No. 62/301,434, filed on Feb. 29, 2016.

(51) Int. Cl. G01C 21/36; G01C 21/20; G08G 5/00; H04W 76/02

(52) U.S. Cl. CPC G01C 21/367; H04W 76/023; G01C 21/203; G08G 5/0082; H04W 4/008

(57) ABSTRACT

An object tracking system includes a mobile platform having a communication module. The communication module is configured to communicate with an object tracking server over a network. The tag is configured to wirelessly communicate with the communication module of the mobile platform. The mobile platform is configured to receive, from the communication module, location data associated with the tag and to send the location data to the object tracking server over the network. The object tracking server is configured to store the location data—an optionally additional data—in a database, receive a request for the location data from a mobile device, and send the location data to the mobile device.

### CROSS-REFERENCE TO RELATED APPLICATIONS

This application claims priority to U.S. Provisional Patent Application No. 62/301,434, filed Feb. 29, 2016, the entire contents of which are hereby incorporated by reference.

### TECHNICAL FIELD

The technical field generally relates to tracking objects, such as objects that communicate with each other in with ad-hoc networks. More particularly, the technical field relates to systems and methods for tracking objects in the context of mobile platforms, such as automobiles and the like.

### BACKGROUND

Recent years have seen an increased interest in wireless connectivity between common household objects and other things that might benefit from communicating with each other (e.g., via ad-hoc networks). This paradigm is often referred to as “Internet of Things.” One feature of this pervasive communication between objects is that it is sometimes possible to determine the location of objects (e.g., when they are lost) by inferring the location based on triangulation or GPS-based location determination or the like using a mobile device (such as a smartphone) able to communicate with tags (via BLUETOOTH or the like) coupled to or integrated into such objects in the environment.

One of the primary challenges posed by locating objects in an Internet of Things context is that, once the objects are out of range of the user's mobile device, then it is difficult or impossible to determine the location of such objects. This is notably the case in which a user carries a tagged object into a mobile platform, such as an automotive vehicle. In such a case, the object is removed from the ad-hoc network or other “mesh” network usually provided by the objects in an “Internet of Things” environment. As such, the user will generally be unable to determine the location of an object left within the mobile platform after the user exits the mobile platform.

Accordingly, it is desirable to provide improved tracking of objects in the context of mobile platforms. Furthermore, other desirable features and characteristics of the present invention will become apparent from the subsequent detailed description and the appended claims, taken in conjunction with the accompanying drawings and the foregoing technical field and background.

### SUMMARY

In accordance with one embodiment, an object tracking system includes a mobile platform having a communication module configured to communicate with an object tracking server over a network. The system further includes a tag associated with an object, the tag configured to wirelessly communicate with the communication module of the mobile platform. The mobile platform is configured to receive, from the communication module, location data associated with the tag and to send the location data to the object tracking server over the network. The object tracking server is configured to store the location data in a database, receive a request for the location data from a mobile device, and send the location data to the mobile device.

A method of tracking an object having a tag associated therewith includes establishing a wireless connection between the tag and a communication module; receiving, at the communication module, location data associated with the tag; sending the location data to an object tracking server over a network; storing, at the object tracking server, the location data in a database; receiving, at the object tracking server, a request for the location data from a mobile device; sending the location data to the mobile device; and displaying the location data on a display of the mobile device.

### DESCRIPTION OF THE DRAWINGS

The exemplary embodiments will hereinafter be described in conjunction with the following drawing figures, wherein like numerals denote like elements, and wherein:

FIG. 1 is a conceptual block diagram of an object tracking system in accordance with an exemplary embodiment;

FIG. 2 is a conceptual block diagram of a mobile platform in accordance with various exemplary embodiments;

FIG. 3 is a conceptual block diagram illustrating the interior of a mobile platform in accordance with various exemplary embodiments;

FIG. 4 is a block diagram of an exemplary mobile device in accordance with one embodiment;

FIG. 5 is a block diagram of an exemplary communication module in accordance with one embodiment;

FIG. 6 is a block diagram of an exemplary object tracking server in accordance with one embodiment;

FIG. 7 is a flow chart illustrating a method in accordance with one embodiment;

FIGS. 8 and 9 depict a user interface for determining the location of an object in accordance with one embodiment; and

FIG. 10 is a conceptual block diagram of a tag in accordance with various exemplary embodiments.

### DETAILED DESCRIPTION

In general, the subject matter described herein relates to an improved method of wirelessly tracking the location of objects in the context of mobile platforms, such as vehicles and the like. In that regard, the following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices.

In addition, those skilled in the art will appreciate that embodiments of the present disclosure may be practiced in conjunction with any number of systems, and that the object tracking system described herein is merely one exemplary embodiment of the present disclosure. For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

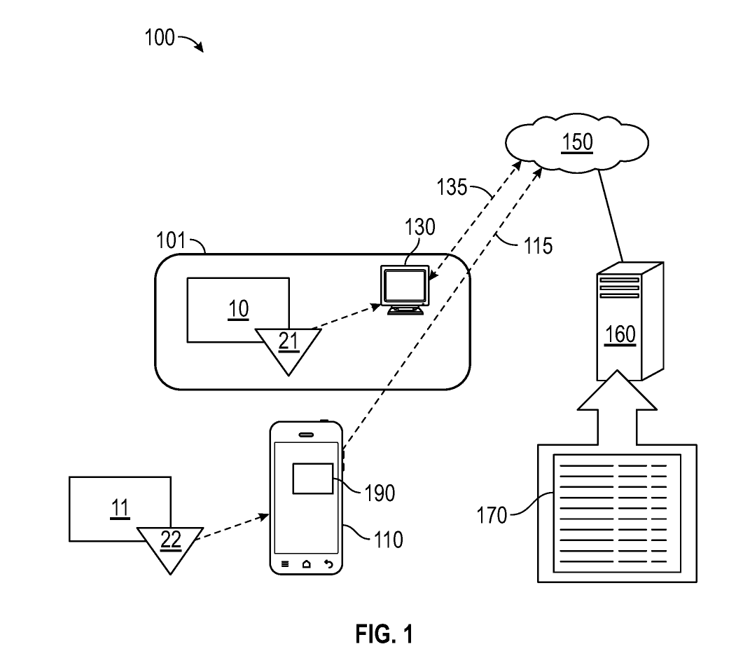

FIG. 1 is a conceptual block diagram of an object tracking system 100 in accordance with an exemplary embodiment. In general, a mobile platform 101 includes a communication module (or simply “module”) 130 that is configured to communicate through an appropriate network or set of networks 150 with an object location server 160. In this regard, “mobile platform” as used herein refers to any structure that is configured to move through its environment, such as an automotive vehicle, an aircraft, a robotic platform, a water-going vessel, or any other such structure now known or later developed.

Network 150 is, in the interest of convenience, illustrated as a single “cloud”, but may in fact comprise a wide variety of networks using any suitable data communication method, such as one or more Internet protocols, cellular communication, an ONSTAR® network, a telematics network, a vehicle-to-vehicle network, or the like.

Within the environment illustrated in FIG. 1, one or more objects (such as objects 10 and 11) may exist with corresponding “tags” 21 and 22, respectively. The term “object” as used in this context refers to any item that may be carried or otherwise moved from place to place, and whose location it is advantageous to track. Non-limiting examples of objects 10 and 11 include mobile computing devices, mobile gaming systems, eyewear and other clothing, key fobs (e.g., to operate mobile platform 101), purses, beverage containers, toiletry items, tools, personal transportation devices (scooters, hoverboards), and the like.

Tags 21 and 22 include any combination of hardware and software configured to communicate with a suitable device, such as a mobile device 110 including interface software 190 and associated hardware, and/or a communication module 130 located onboard (e.g., integral with) mobile platform 101. Mobile device 110 may include, for example, a smart-phone, a tablet computer, a portable computing device, or the like. In one embodiment, for example, tags 21 and 22 are BLUETOOTH devices configured to communicate with module 130 and/or mobile device 110 using the low-power BLUETOOTH (sometimes referred to as BLUETOOTH LP protocol or “BLE” (BLUETOOTH Low Energy). In other embodiments tags 21 and 22 communicate via ultra-wide-band (UWB) data transfer, 802.11 (WiFi), near-field communication (NFC) or the like. The range of embodiments are not so limited, however, and include any wireless protocol now known or later developed. In some embodiments, tags 21 and 22 are able to determine their own location relative to some reference location (i.e., a nearby mobile device). In other embodiments, tags 21 and 22 merely act as “beacons” with little or no local knowledge regarding their location. In the latter case, the location of the mobile device that communicates with tags 21 and 22 is itself used to infer the location data associated with tags 21 and 22. In another embodiment, the location information inferred by the wireless communication protocol is merely partial in the sense it does not provide a complete location of the tag (e.g., it provides ranging information without direction to the tag).

Tags 21 and 22 are illustrated in FIG. 1 as coupled (e.g., removeably or non-removeably fixed) to their respective objects 10 and 11. In some embodiments, however, the functionality of tags 21 and 22 are integral to the object to which they are attached (e.g., via one or more semiconductor devices). That is, for example, as is often the case with the “Internet of Things,” objects may include their own on-board tag hardware and software. Tags 21 and 22 may be similar in operation to tags produced by PIXIE, further information regarding which may be found at www.getpixie.com. Such tags are low-power BLUETOOTH tags that interconnect and, using triangulation and/or range extension technology, are able to determine with reasonable accuracy their positions in space relative to each other. As noted in the Background section above, however, such tags only operate optimally in the vicinity of other tags or related devices, so that their effectiveness is reduced when the tags are located in a mobile platform that is far from other such tags.

As illustrated in FIG. 1, tags 21 and 22 are configured to communicate with module 130 and mobile device 110 through suitable software (such as application 190). This communication may be established automatically (e.g., when tags 21 and 22 come within range of a suitable communication device, such as module 130 or mobile device 110) or manually through interaction with a user (such as a user interface provided by application 190). Both module 130 and mobile device 110 include some form of positioning capability for determining their own locations in the environment. In some embodiments, both module 130 and mobile device 110 include a global positioning system (GPS) module, as is known in the art. In other embodiments, WiFi and/or cellular positioning or the like may also be used.

In any event, once communication has been established with module 130 and/or mobile device 110, information regarding the tagged objects 10 and 11 is “registered” (via network 150) with server 160. This registration may be done manually or automatically, and includes server 160 storing database 170 that specifies, for each object 10 and 11, identifying information for that object as well as location data for that object. In that regard, database 170 may be of any known format and may include any suitable data structure. In one embodiment, for example, database 170 includes a user identifier (e.g., the name or unique login credentials of the user registering the tag), a unique identifier for the object (e.g., “001569882”), an alphanumerical description of that object (e.g., “Erica's IPhone”), and coordinates in space (e.g., latitude/longitude/altitude) specifying the location of the object (e.g., “33.578295,−111.9295977,17z”). Database 170 might also include an emergency level (e.g., “high”, “medium”, “low”) that the user attaches to this object. For example, a medication might be associated with a high level of emergency while a toy might be associated with a very low level of emergency. The subject matter is not so limited, however, and comprehends a variety of data formats and types. In some embodiments, database 170 is encrypted such that it can only be accessed by the registering user. Additionally, the data structure may have also a time tagged field associated with the last time the object has been seen and/or updated in the database. The database may be of a proprietary structure for this application and may also be an of the shelf existing database solutions, secured database, distributed and such.

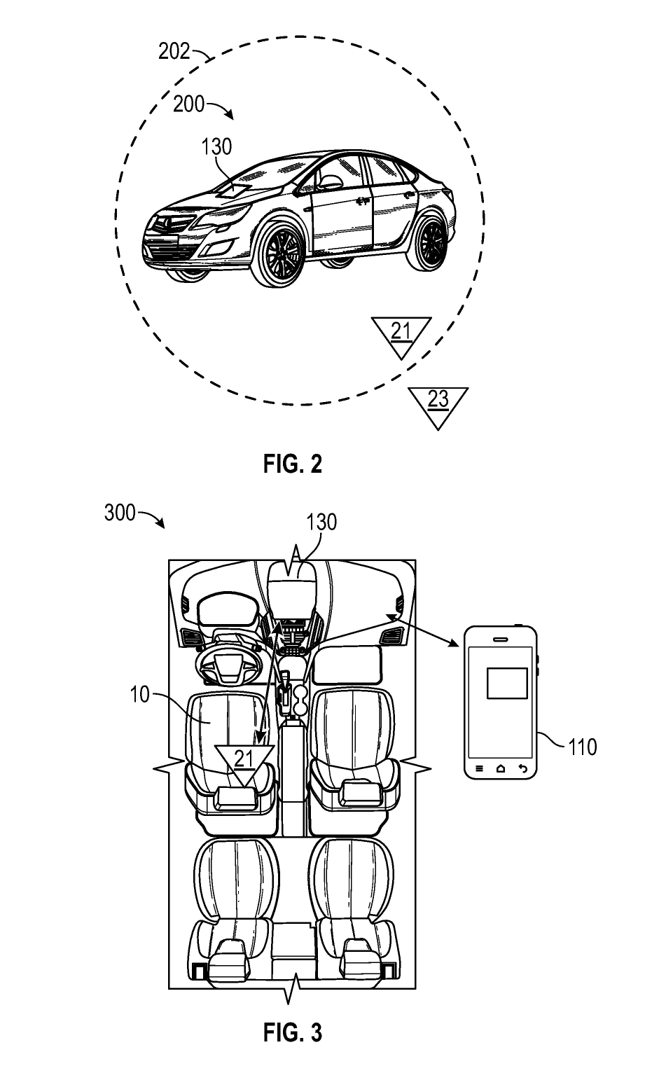

FIG. 2 is a conceptual block diagram of a mobile platform in accordance with various exemplary embodiments, in which the mobile platform 101 of FIG. 1 is implemented as an automotive vehicle 200. As illustrated, module 130 has a particular range of communication 202. Tags that are outside of range 202 (e.g., tag 23), will generally not be able to communicate with module 130, while tags that are inside range 202 (e.g., tag 21), will be able to communicate with module 130. In that regard, FIG. 3 is a conceptual block diagram illustrating the interior 300 of the vehicle 200 of FIG. 2 but is not limited necessarily to the interior only.

It will be appreciated that there may be intervals in which a tag (such as tag 23 of FIG. 2) is out of range 202 of all mobile platforms and mobile devices. That is, for example, a user's tagged object may be left in a grocery store such that is not within range of the user's mobile phone 110 or mobile platform 101 (and hence module 130). In such cases, however, other mobile devices or mobile platforms may move within range of tag 23 and provide server 160 with updated location information for that tag 23, even if that mobile device or mobile platform is not owned or otherwise associated with the user that registered tag 23. That is, using the current example, another user's smartphone (comparable to mobile device 110, and including suitable software 190) may move within range of the lost mobile device 110 within the grocery store briefly, allowing that mobile device to update database 170 in a secure manner. Stated another way, the location of one or more objects in the environment can be updated in the database 170 via other mobile devices 110 and/or mobile platforms 101 in proximity to and in communication with the tag of the respective object.

As shown in FIG. 3, tag 21 associated with object 10 has established communication with module 130, as has the mobile device 110. In such an embodiment, mobile device 110 and module 130 may “share” information regarding the location of tag 21. That is, mobile device may “hand off” the duty of specifying the location of tag 21 to module 130, such that module 130 updates (either automatically at predetermined intervals and/or manually) the location of tag 21 within database 170 of FIG. 1. Module 130 may be component of a pre-existing computing device incorporated into mobile platform 101, such as the “infotainment system” used for user interaction with various subsystems of mobile platform 101, such as navigation, climate control, audio, and the like. Module 130 might also be an aftermarket module installed within mobile platform 101.

Once the location of tag 21 has been registered with database 170 via server 160, the user may then interrogate the system to determine the location of tag 21 (and by extension the object 10 to which is associated). This may be performed, for example, by user interaction with application 190 on mobile device 110, which is configured to interrogate database 170 via server 160 over network 150 of FIG. 1.

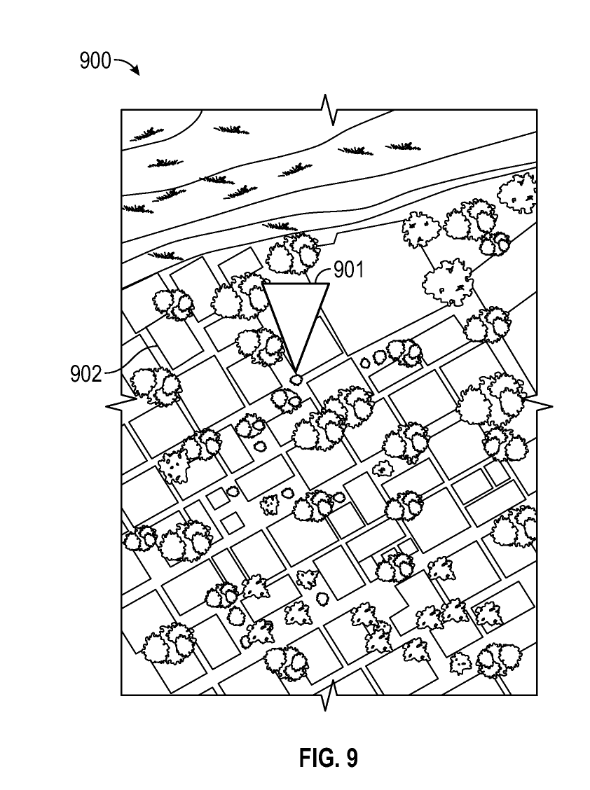

FIGS. 8 and 9 depict an example user interface for determining the location of a tag (such as tag 10) in accordance with one embodiment. This user interface may be used in connection with mobile device 110 or module 130. In FIG. 8, a user interface 800 is shown, including a displayed list of object identifiers 801, 802, 803, etc. The illustrated list is populated via location data 170, and would generally include all known tags associated with a particular user. Thus, for example, item 801 may be “Dan's Sunglasses2”, item 802 may be “Spencer's Phone”, item 803 may be “Carter's Pikachu”, etc. User interface 800 is further configured such that the user may select one of the items 801-803 via a user interface device, such as a touch-screen, a keyboard, speech input, or the like. Once the item has been selected, a second user interface may be displayed in order to indicate the location of the associated object/tag. Referring to FIG. 9, for example, the user interface 900 might include a map 902 and a corresponding location indicator 901. The user may also be provided the opportunity to request driving or walking directions to the corresponding tag.

FIG. 7 is a flow chart illustrating a method in accordance with one embodiment, and will be described in conjunction with the system shown in FIG. 1. Initially, at 702, a connection (e.g., a BLUETOOTH LP connection) is established between tag 21 and module 130. As mentioned above, this connection may be established manually or automatically.

Next, in 704, the tag (e.g., tag 21) is registered with server 160 by establishing data communication with server 160 over network 150. Such registration includes at least the transfer of tag identification data for tag 21 as well as location data (e.g., GPS data) associated with the device that established communication with tag 21 in block 702—e.g., module 130 or mobile device 110. This information is stored within database 170 and updated as necessary by device 130 and/or mobile device 110 as the corresponding object 10 moves through its environment. In this regard, it should be noted that location data is “associated” with tag 21 in the sense that the location of mobile device 110 (and/or module 130) is known (e.g., via GPS), and it is also known that tag 21 is within range of communication with mobile device 110 and/or module 130. The location of tag 21 is then inferred based on the location of mobile device 110 and/or module 130. In other embodiments, however, tag 21 may know its own location with relative accuracy (e.g., by communication with one or more additional tags nearby). In such a case, tag 21 may transmit that location data to mobile device 110 and/or module 130, increasing the accuracy of the location data. In another embodiment, the position accuracy is also inferred and reported to be registered as anther field in the object registry in the database.

In 706, the user interrogates database 170 via server 160 over network 150 to determine the location of tag 21. This may be done, for example, so that the user can locate object 10 when it has been lost, and may be accomplished, for example, via software 190 running on mobile device 110. As mentioned previously, FIG. 8 presents just one user interface 800 that may be used to accomplish this task.

As a result of the interrogation performed in 706, location data stored within database 170 for tag 21 is sent via server 160 and network 150 to mobile device 110. That information is displayed for the user—e.g., via a map 902 as shown in FIG. 9.

In accordance with another embodiment, the database is accessed through a human interface, such as a service center facility. This embodiment provides the option of having a shared medium experience, such as movie theater, shopping mall, or shared cars and wherein the object searched is accessed seamlessly with a third party communication device. This option suggests a center initiated object search using a wide range of communication devices existing in a range of interest (e.g., where a lost object was last tracked). In accordance with this embodiment, the location of the object is provided as a service through a crowd of communication devices that have not been originally associated with the object and the credentials for accessing the object are transferred from the server side. This mode is preferably seamless and protected from the object owner. Namely, the “middle-man's” communication devices are providing the interaction with the object searched to the server without letting the communication device owner see information regarding the object location, affiliation and type. Finally, the listed services may include shipment services targeting returning the object to the object owner.

In another embodiment, a proactive system is provided wherein the system can run a “check” service at a certain interval of time (e.g., once a day) and send messages to users that have not been searching for their objects that remained in the mobile platforms. More particularly, the timing and content of message might change according to the level of the emergency of the object.

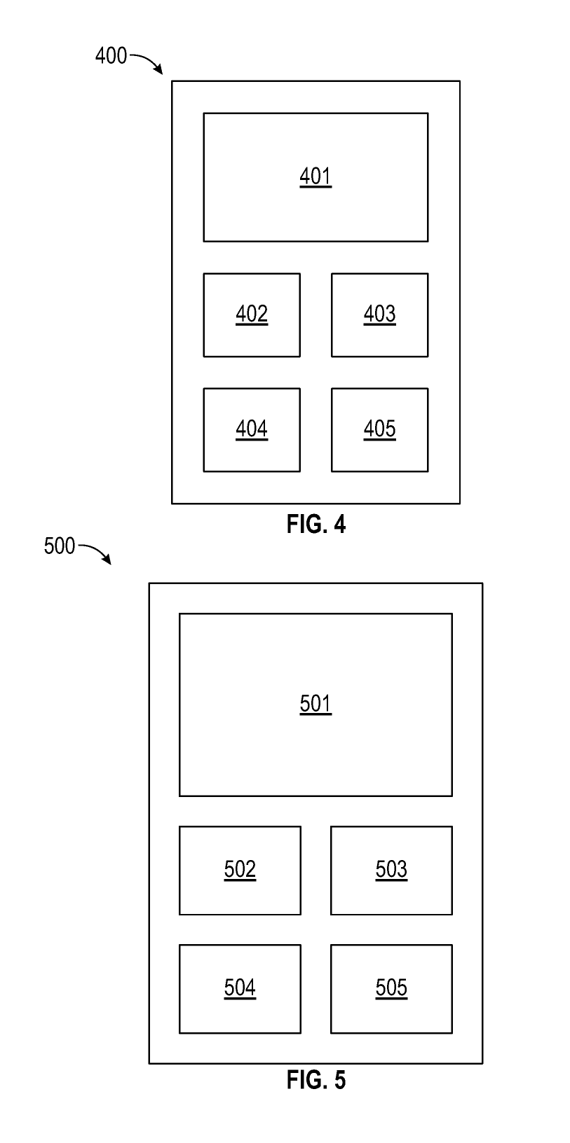

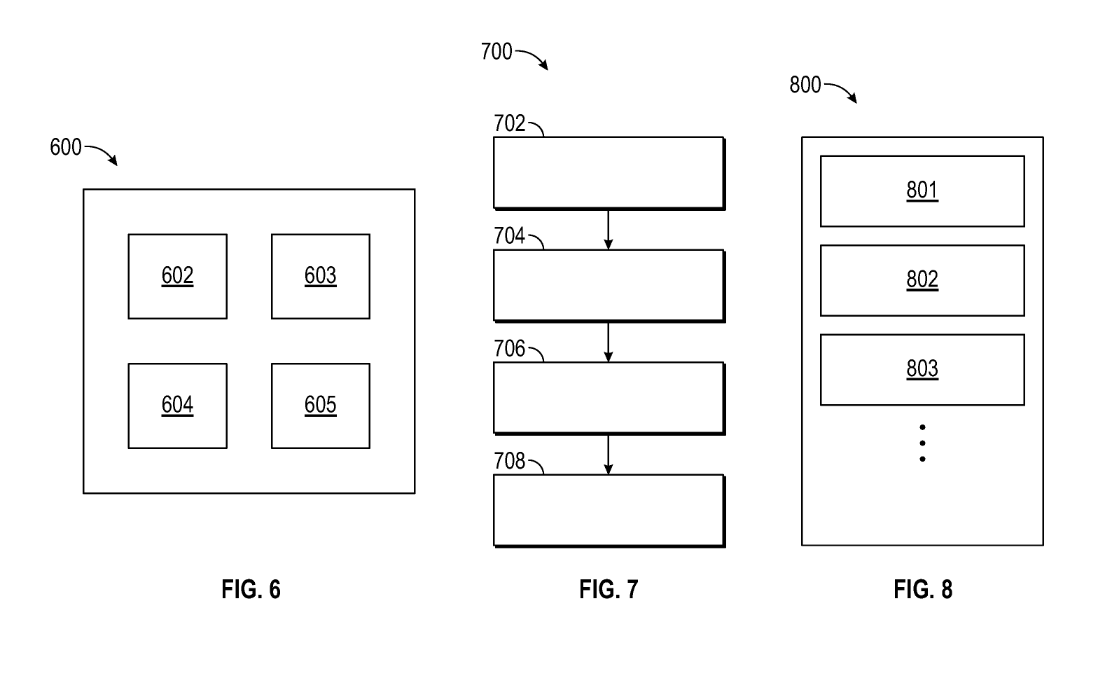

The various systems and devices shown in FIG. 1 may be implemented using a variety of software and hardware components. FIGS. 4-6 and 10 depict, in block diagram form, various examples, which will now be described in detail.

FIG. 4 is a block diagram of an exemplary mobile device 400 (e.g., corresponding to mobile device 110) in accordance with one embodiment. Furthermore, it will be understood that the various components of tag 21 may interoperate via a data bus or other communication method known in the art. As shown, mobile device 400 includes a display (e.g., a touch-screen display 401), a processor 402, a memory component (e.g., ROM, RAM, or the like) 403, a storage component 404 (e.g., detachable or integrated memory), a user input device (not illustrated), and a network interface 405 (e.g., WiFi, 4G, 5G, etc.). Similarly, FIG. 5 is a block diagram of an exemplary communication module 500 (e.g., module 130 of FIG. 1) in accordance with one embodiment. It will be understood that the various components of tag 21 may interoperate via a data bus or other communication method known in the art. In general, the user may interact with mobile device 400 via any convenient modality, including, for example, visual, touch, speech, gestures, and the like.

In this embodiment, module 500 includes a display 501 (e.g., a touch-screen or other display), an input device, a processor 502, a memory component 503, a storage component 404, and a network interface 505. Server 600 (corresponding to server 160 in FIG. 1) similarly includes a processor 602, a storage component 604, a memory component 603, and a network interface (e.g., Ethernet, WiFi, 4G, etc.) The server entity 600 (and/or database 170) may also be a virtual machine in a distributed form or leased by a service provider.

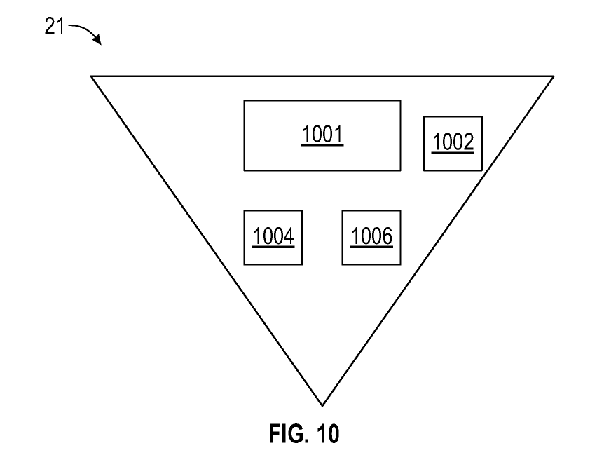

FIG. 10 is a conceptual block diagram of a tag 21 in accordance with various exemplary embodiments. As shown, tag 21 includes a processor 1001, a memory component 1002, a storage component 1004, and a network interface 1006. As mentioned previously, network interface 1006 may correspond to a BLUETOOTH LP interface, as is known in the art. While not shown in FIG. 10, tag 21 may include various attachment methods (e.g., adhesives, clips, screws, etc.) that allow it to be attached to corresponding objects. Furthermore, it will be understood that the various components of tag 21 may interoperate via a data bus or other communication method known in the art.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An object tracking system comprising:
a mobile platform including a communication module configured to communicate with an object tracking server over a network;
a tag associated with an object, the tag configured to wirelessly communicate with the communication module of the mobile platform;
wherein the communication module is configured to receive location data associated with the tag to the object tracking server over the network;
wherein the object tracking server is configured to store the location data in a database, receive a request for the location data from a mobile device, and send the location data to the mobile device.

2. The object tracking system of claim 1, wherein the mobile platform is configured to receive the location data and display the location data on a display in response to a user request.

3. The object tracking system of claim 2, wherein the display of the location data includes displaying an image of a map and an indicator on the map corresponding to the location data associated with the tag.

4. The object tracking system of claim 1, wherein the mobile platform is selected from the group consisting of an automotive vehicle, a motorcycle, a train, a bus, a water-going vessel, and an aircraft.

5. The object tracking system of claim 1, wherein the tag is configured to communicate with the communication module via a low-power BLUETOOTH protocol.

6. The object tracking system of claim 1, wherein the mobile device is further configured to share location data associated with the tag with the communication module of the mobile device.

7. The object tracking system of claim 1, wherein the location data includes an identifier of the object and coordinate information regarding the last known location of the object.

8. The object tracking system of claim 7, wherein the communication module is configured to send the location data to the object tracking server at predetermined intervals.

9. A mobile platform comprising:
a communication module configured to communicate with an object tracking server over a network and to wirelessly communicate with a tag associated with an object located within a predetermined range of the communication module;
wherein the communication module is configured to send location data associated with the tag to the object tracking server over the network.

10. The mobile platform of claim 9, wherein the communication module is further configured to request location data associated with the tag from the object tracking server.

11. The mobile platform of claim 9, wherein the mobile platform is selected from the group consisting of an automotive vehicle, a water-going vessel, and an aircraft.

12. The mobile platform of claim 9, wherein the communication module is configured to communicate with the tag via a low-power BLUETOOTH protocol.

13. The mobile platform of claim 9, wherein communication module is configured to share location data associated with the tag with a mobile device.

14. The mobile platform of claim 9, wherein the location data includes an identifier of the object and coordinate information regarding the last known location of the object.

15. The mobile platform of claim 9, wherein the communication module is configured to send the location data to the object tracking server at predetermined intervals.

16. A method of tracking an object having a tag associated therewith, the method comprising:
establishing a wireless connection between the tag and a communication module;
receiving, at the communication module, location data associated with the tag;
sending the location data to an object tracking server over a network;
storing, at the object tracking server, the location data in a database;
receiving, at the object tracking server, a request for the location data from a mobile device;
sending the location data to the mobile device; and
displaying the location data on a display of the mobile device.

17. The method of claim 16, further including displaying the location data as an image of a map and an indicator on the map corresponding to the location data associated with the tag.

18. The method of claim 16, wherein the wireless connection between the tag and the communication module is established via a low-power BLUETOOTH protocol.

19. The method of claim 16, wherein the location data includes an identifier of the object and coordinate information regarding the last known location of the object.

20. The method of claim 16, further including sending the location data to the object tracking server at predetermined intervals.
